(19) United States
(12) Patent Application Publication
(10) Pub. No.: US 2017/0010060 A1
(43) Pub. Date: Jan. 12, 2017

(54) HETEROGENEOUS SURFACES FOR PATTERNED BUBBLE ARRAYS, ENHANCED HEAT TRANSFER, & ADVANCED HEAT EXHANGER APPLICATIONS

(71) Applicants: Chih-Hung CHANG, Corvallis, OR (US); Chang-Ho CHOI, Corvallis, OR (US); Michele David, Corvallis, OR (US)

(72) Inventors: Chih-Hung CHANG, Corvallis, OR (US); Chang-Ho CHOI, Corvallis, OR (US); Michele David, Corvallis, OR (US)

(21) Appl. No.: 15/202,436

(22) Filed: Jul. 5, 2016

Related U.S. Application Data
(60) Provisional application No. 62/189,125, filed on Jul. 6, 2015.

(51) Int. Cl. F28F 13/18; F28F 21/06; F28F 21/08; B41J 11/00

(52) U.S. Cl. CPC F28F 13/187; B41J 11/0015; F28F 21/06; F28F 21/081; F28F 2245/02; F28F 2245/04; F28F 2255/20

(57) ABSTRACT

Heterogeneous surfaces to tailor bubble nucleation, bubble sites, and bubble dynamics. In some embodiments, piezoelectric inkjet printing is employed to deposit hydrophobic polymer dot arrays having any predetermined pattern. In some further embodiments, a field region comprising hydrophilic nanostructures further surrounds these dot arrays. The hydrophobic sites may be disposed at a crater bottom to enhancing wicking and replenishment of evaporate. In some embodiments, a heat exchanger comprises the heterogeneous surface for enhanced critical heat flux. In some embodiments, an apparatus for conveying information comprises the heterogeneous surface to generate a 2D binary image with each bubble serving as an image pixel that corresponds to one or more site within the heterogeneous surface.

### CROSS-REFERENCE TO RELATED APPLICATIONS

This application is a non-provisional application of U.S. provisional application No. 62/189,125, filed on Jul. 6, 2015, the subject matter of which is incorporated herein by reference in its entirety for all purposes.

### GOVERNMENT LICENSE RIGHTS

This invention was made with government support under Grant No. CBET-1449383 awarded by NSF Scalable Nanomanufacturing and OSU Venture Development Fund. The government has certain rights in the invention.

### BACKGROUND

Electronic system energy management and cooling for future advanced energy and electronic systems such as concentrated photovoltaics, lasers, radars, and power electronics are getting more challenging, resulting in a search for technologies and design techniques to dissipate ultra-high heat fluxes. One of the most promising approaches is to utilize the large latent heat of vaporization in a two-phase system, and thus boiling heat transfer has been widely investigated. A variety of methods have been used to engineer the boiling surface for enhanced heat transfer performance. The most straightforward approach is to increase the available heat surface area by introducing structures such as fins on the surface. Another useful method is to increase boiling nucleation sites by controlling the surface texture. Roughening the surface to create pits and cavities, for example, is a well-studied technique to increase the heat transfer coefficient (HTC) by increasing boiling nucleation site density. Engineering the chemical properties of boiling surfaces such as wettability is another effective approach to enhance boiling heat transfer. Hydrophobicity, for example, leads to an earlier activation of nucleation sites known as onset of nucleate boiling (ONB). Hydrophobicity may also enhance vapor trapping, which serves as a catalyst for bubble nucleation. Many have also examined the role of hydrophilic surfaces for facilitating liquid water transport to enhance the critical heat flux (CHF).

The engineering of bubble nucleation control, growth and departure dynamics plays a significant role in enhancing heat transfer performance due to the association with the latent heat of vaporization. Recent developments in nanofabrication techniques provide a new set of tools to fabricate enhanced boiling heat transfer surfaces, through the design of boiling surfaces at nano and micro scales. In recent years, heterogeneous surfaces with dual hydrophobic and hydrophilic properties have been proposed as superior boiling surfaces compared to homogeneous hydrophilic surfaces. A number of research groups have reported the use of micro- and nanostructures on boiling surfaces such as micro meshes, copper, silicon and ZnO nanowires, carbon nanotubes, nanoporous copper, zirconium, silicon and aluminum oxide to increase HTC and CHF. Engineering the wettability contrast of the surface holds great potential to enhance the heat transfer in both boiling and condensation processes. In condensation, water droplet nucleation occurs on a hydrophilic surface and departs on a hydrophobic surface. The use of biphilic surfaces with mixed wettability offers the opportunity to design ideal boiling and/or condensation surfaces compared to homogeneously hydrophobic or hydrophilic surfaces.

To date most of the reported heterogeneous surfaces are prepared with a lithographic technique, involving multiple processes and external sources for the patterned heterogeneous surface, thereby resulting in high capital cost and low throughput. Additionally, these heterogeneous surfaces have been developed on brittle silicon substrates, rendering them unsuitable for widely practical applications of boiling surfaces. Furthermore, none have addressed spatial control of bubble nucleation and bubble dynamics as a function of heterogeneous surface architecture, which may provide a basis for enhancing boiling performance. For example, spatial control of bubble nucleation may be beneficial in flow boiling applications where the heat transfer performance and stability can be highly sensitive to the location of bubble nucleation.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements. In the figures:

FIG. 1A illustrates an isometric view of a heterogeneous boiling surface, in accordance with some embodiments;

FIG. 1B illustrates a cross-sectional view of the heterogeneous boiling surface depicted in FIG. 1A, in accordance with some embodiments;

FIG. 2A illustrates an isometric view of an arrayed heterogeneous boiling surface, in accordance with some embodiments;

FIG. 2B is an optical image of a spatially patterned bubble nucleation array generated by an arrayed heterogeneous boiling surface, in accordance with some embodiments;

FIG. 3 is a flow diagram illustrating methods of fabricating a heterogeneous boiling surface, in accordance with some embodiments;

FIG. 4 are isometric views of a heterogeneous boiling surface evolving as operations in the methods illustrated in FIG. 3 are performed, in accordance with some embodiments;

FIG. 5 illustrates heterogeneous boiling surfaces and corresponding major bubble site morphologies, in accordance with some embodiments;

FIG. 6 is a table of diameter and pitch for printed dot arrays employed as hydrophobic sites in a heterogeneous boiling surface, in accordance with some embodiments;

FIGS. 7 and 8 are graphs of the bubble departure frequency as a function of printed dot diameter and pitch, in accordance with some embodiments;

FIG. 9A is a graph plotting water boiling curves for homogeneous, and heterogeneous surfaces in accordance with some embodiments;

FIG. 9B is a graph plotting heat transfer coefficient for homogeneous, and heterogeneous surfaces in accordance with some embodiments;

FIG. 10 is a table comparing water evaporation rates for homogeneous, and heterogeneous boiling surfaces in accordance with some embodiments;

FIG. 11 is a flow diagram and schematic illustrating application of a heterogeneous boiling surface in a heat exchanger, in accordance with some embodiments; and

FIG. 12 illustrates a heat pipe employing a heterogeneous boiling surface, in accordance with some embodiments.

### DETAILED DESCRIPTION OF EXEMPLARY EMBODIMENTS

One or more embodiments are described with reference to the enclosed figures. While specific configurations and arrangements are depicted and discussed in detail, it should be understood that this is done for illustrative purposes only. Persons skilled in the relevant art will recognize that other configurations and arrangements are possible without departing from the spirit and scope of the description. It will be apparent to those skilled in the relevant art that techniques and/or arrangements described herein may be employed in a variety of other systems and applications other than what is described in detail herein.

Reference is made in the following detailed description to the accompanying drawings, which form a part hereof and illustrate exemplary embodiments. Further, it is to be understood that other embodiments may be utilized and structural and/or logical changes may be made without departing from the scope of claimed subject matter. It should also be noted that directions and references, for example, up, down, top, bottom, and so on, may be used merely to facilitate the description of features in the drawings. Therefore, the following detailed description is not to be taken in a limiting sense and the scope of claimed subject matter is defined solely by the appended claims and their equivalents.

In the following description, numerous details are set forth. However, it will be apparent to one skilled in the art, that embodiments may be practiced without these specific details. In some instances, well-known methods and devices are shown in block diagram form, rather than in detail, to avoid obscuring the embodiments. Reference throughout this specification to “an embodiment” or “one embodiment” or “some embodiments” means that a particular feature, structure, function, or characteristic described in connection with the embodiment is included in at least one embodiment. Thus, the appearances of the phrase “in an embodiment” or “in one embodiment” or “some embodiments” in various places throughout this specification are not necessarily referring to the same embodiment. Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “coupled” and “connected,” along with their derivatives, may be used herein to describe functional or structural relationships between components. It should be understood that these terms are not intended as synonyms for each other. Rather, in particular embodiments, “connected” may be used to indicate that two or more elements are in direct physical, optical, or electrical contact with each other. “Coupled” may be used to indicated that two or more elements are in either direct or indirect (with other intervening elements between them) physical or electrical contact with each other, and/or that the two or more elements co-operate or interact with each other (e.g., as in a cause an effect relationship).

The terms “over,” “under,” “between,” and “on” as used herein refer to a relative position of one component or material with respect to other components or materials where such physical relationships are noteworthy. For example in the context of materials, one material or material disposed over or under another may be directly in contact or may have one or more intervening materials. Moreover, one material disposed between two materials or materials may be directly in contact with the two layers or may have one or more intervening layers. In contrast, a first material or material “on” a second material or material is in direct contact with that second material/material. Similar distinctions are to be made in the context of component assemblies.

As used throughout this description, and in the claims, a list of items joined by the term “at least one of or” one or more of can mean any combination of the listed terms. For example, the phrase “at least one of A, B or C” can mean A; B; C; A and B; A and C; B and C; or A, B and C.

Heterogeneous surfaces to enhance and/or control bubble nucleation, bubble sites, and bubble dynamics are described further below. In some embodiments, nano and micro-scale structures are combined into a boiling surface to generate large-scale, patterned arrays of bubbles. Such bi-functional boiling surfaces may be fabricated on large-size substrates, such as stainless steel, suitable for further integration into a heat exchanger. Such substrates may be thin enough to be sufficiently flexible to shaped and bond to a surface of most any three-dimensional (3D) object. In some embodiments, piezoelectric inkjet printing is employed to deposit hydrophobic polymer dot arrays. Such a process has the advantages of cost, flexibility, and scalability when compared to conventional photolithography and etching processes. The direct writing ability of the printer enables the fabrication of the heterogeneous surfaces with variously configured spatial arrays of features. For example, a macroscopic array pattern may include variable polymer dot sizes and pitch values down to micron dimensions. In some further embodiments, a field region comprising hydrophilic nanostructures further surrounds the arrayed dots. In some such embodiments, the hydrophilic nanostructures are formed by Microreactor-Assisted Nanoparticle Deposition (MAND). For such a solution-based deposition processe, the high wettability contrast between hydrophobic polymer dot arrays and aqueous ZnO solution, ZnO deposition may be made selective to the hydrophilic region of the substrate.

In some embodiments, a high wettability contrast between hydrophobic polymer dot arrays and aqueous ZnO solution is employed to prevent ZnO nanostructure formation on the hydrophobic region and successfully manufacture the heterogeneous surface. Some exemplary heterogeneous surface architectures and manufacturing embodiments are described further below.

### Heterogeneous Surfaces & Architecture

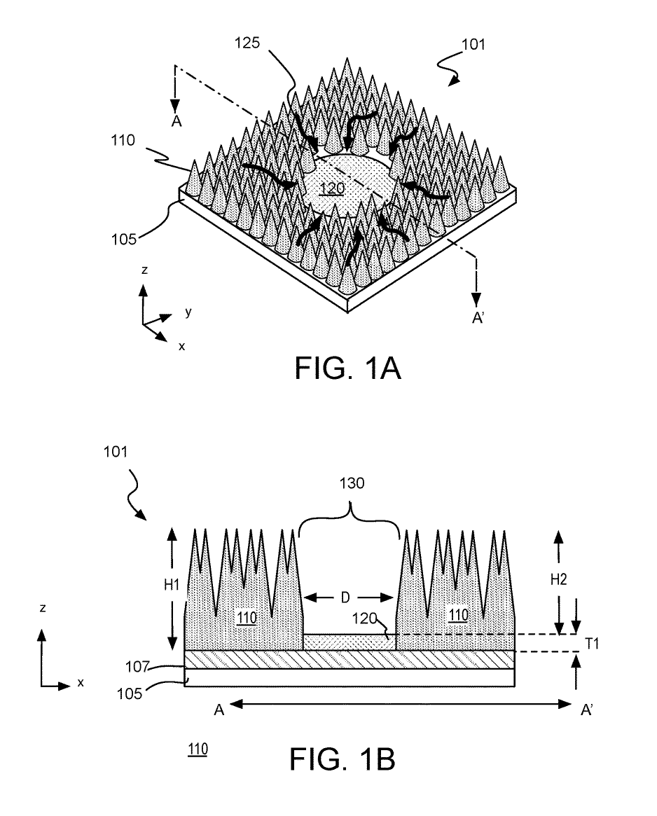

In accordance with some embodiments, heterogeneous surfaces include a plurality of thin-films disposed over adjacent areas of a substrate. FIG. 1A illustrates an isometric view of a heterogeneous boiling surface 101, in accordance with some embodiments. FIG. 1B illustrates a cross-sectional view of the heterogeneous boiling surface 101, in accordance with some further embodiments. Heterogeneous surface 101 includes a hydrophobic surface site or feature 120 surrounded by field material 110 having hydrophilic surfaces. The materials of site 120 and field 110 are both disposed over a substrate 105. In an alternative embodiment, polarity is reversed from that illustrated in FIG. 1A, 1B such that a hydrophilic site is surrounded by a hydrophobic field area. Any of the attributes described below in the context of the illustrative embodiment depicted in FIG. 1A, 1B may therefore also be applied to an alternative embodiment having reverse polarity.

Substrate 105 may be selected from a wide variety of candidate materials and/or material stacks, particularly where exemplary fabrication techniques maintain low temperatures (e.g., below 200° C., or even 150° C.) throughout the heterogeneous surface fabrication process. Exemplary substrates include organic substrates (e.g., polymers, paper products, textiles, etc.), insulative glasses (e.g. oxidize silicon, aluminum oxide, etc.), metals (e.g., copper, aluminum, stainless steel, etc.), and crystalline semiconductors (e.g., silicon, SiC, sapphire, etc.). Substrate 105 may have a polished or textured (e.g., milled) surface. In some advantageous embodiments substrate 105 is flexible. Substrate 105 may be any thickness, for example as thin as needed for the substrate to be sufficiently pliable or flexible to be shaped and/or bonded to a desired 3D form. Substrate 105 may be less than 100 μm thick for higher modulus substrate materials (e.g., glasses or crystalline semiconductors), or many hundreds to many thousands of microns in thickness for lower modulus substrate materials, such as stainless steel or copper.

In some advantageous embodiments, at least one of the hydrophilic and hydrophobic materials is a nanostructured material. In the illustrative embodiment shown in FIGS. 1A and 1B, field material 110 is a nanostructured hydrophilic material. As used herein, a nanostructured material has structural features with a nanoscale length (e.g., less than 1000 nm). In some embodiments, the nanostructured material comprises a plurality of nanoparticles with an average diameter less than 400 nm, and advantageously between 10 and 50 nm (e.g., average diameters of 20-40, 25-35 nm, or about 30 nm, etc.). As depicted for field material 110, the nanostructured material may be in the form of a nanowire matrix or “nanoforest” in which the nanostructures have a longitudinal length that predominantly extend away from the surface of the substrate. This nanostructure may offer porosity with amplified capillary action. Porosity may be varied by growth conditions and/or growth duration. Other nanoparticulate surface morphologies, such as nanotubes and nanoporous films are also possible as a function of the material composition and deposition process(es) employed.

Wettability of the exemplary heterogeneous surfaces may be characterized by a contact angle measurement with a static sessile drop method (FTA 137). For exemplary embodiments, the average contact angle was estimated by dropping 2 μL of D.I. water on five different areas of the hydrophobic and hydrophilic surfaces. The shape of the water droplet was captured using a camera, and the contact angle was estimated from the captured image.

Field material 110 may comprise any material having a sufficiently hydrophilic surface character. In some embodiments, hydrophilic field has a contact angle less than 50°, and advantageously ˜20°. In some embodiments, field material 110 is metal, or a metallic oxide. In some exemplary embodiments the metallic oxide comprises a transition metal, such as, but not limited to ZnO. ZnO can be advantageously deposited into a nanostructured hydrophilic material with a corresponding contact angle of ˜20°. ZnO nanoparticles may also be readily deposited with an average size less than 400 nm, and advantageously between 10 and 50 nm (e.g., average diameters of 20-40, 25-35 nm, or about 30 nm, etc.). Other ionic compounds with similar properties may also be employed as field material 110. Site 120 may comprise any material having a desired wettability contrast with field material 110. For examples where field material 110 comprises a hydrophilic material, site 120 has a sufficiently hydrophobic surface character to achieve the desired wettability contrast. In some embodiments, hydrophobic site 120 has a contact angle of at least 70°, and advantageously 110°, or more.

In some embodiments, hydrophobic site 120 comprises a polymer, such as, but not limited to perfluoropolyether (PFPE). In one exemplary PFPE embodiment, ethoxysilane terminal groups provide a hydrophobic material surface with a contact angle of ˜110°. Other PFPEs may also be employed as the hydrophobic feature. Site 120 may also comprise another fluorinated silane material. Site 120 may also comprise an alternative fluorinated material. As further illustrated in FIG. 1B, site 120 comprises a material having average (nominal) film thickness T₁. Nominal film thickness T₁ may vary above some threshold at which surface hydrophobicity is ensured. In some embodiments, nominal film thickness T₁ is at least 5 nm, and advantageously at least 10 nm. Site 120 may further comprise a plurality of material layers, for example indicative of an iterative deposition process. The plurality of material layers may even include artifacts of field material 110, for example indicative of an imperfectly selective deposition of field material 110.

In some embodiments, the top surface of site 120 is recessed below surrounding surfaces of field material 110. The recessed top surface may promote vapor traps to initiate nucleation in the hydrophobic (e.g., polymer) recess 130. For embodiments where the substrate surface is substantially planar under site 120 and the field material 110, the recessed top surface of site 120 may be of field material 110 having a nominal z-height or film thickness H₁ that is significantly greater than the hydrophobic material film thickness T₁. The difference in nominal film thicknesses T₁ and H₁ is the recess depth H₂. In exemplary embodiments, recess depth H₂ is at least 10 nm, an advantageously 50-200 nm, or more. In some PFPE/ZnO embodiments for example, H₂ is at least 100 nm, and advantageously between 300 and 900 nm. With the hydrophobic surface of site 120 at a lower level than many of the hydrophilic surfaces of field material 110, fluidic wicking from field material 110 to site 120 may be enhanced relative to a configuration where a hydrophobic site is at the same level as, or lower than, the wicking structures. In other words, the surfaces of nanostructures 110 channel the liquid easily “downhill” into recess 130 rather than just at the same level or even “uphill”.

The exemplary “crater-forest” structure illustrated in FIG. 1A depicts liquid flow 125 into recess 130 via capillary action through nanostructures of field material 110. The interfacial contact between each functional region 110, and 120 may impact the boundary layer mixing and therefore impact the bubble diameter and frequency. It is thought that the downhill configuration exemplified in FIGS. 1A and 1B promotes boundary layer mixing and stronger bubble motion leading to coalescence as literature indicates that stronger bubble motion may promote faster coalescence and quicker departure. The inventors have more specifically found that the hydrophobic crater-hydrophilic forest, downhill flow configuration depicted in FIGS. 1A and 1B significantly alters bubble mixing action.

While “crater-forest” structure illustrated in FIG. 1A may be advantageous for a boiling surface, embodiments with other surface topology is also possible. For example, the top surface of site 120 may be elevated relative to surfaces of field material 110. Such an architecture may be suitable for condensation surfaces, for example. The top surface of site 120 may also be elevated relative to surfaces of field material 110 for embodiments where the polarity of the hydrophilic and hydrophobic surfaces is reversed from that illustrated in FIG. 1A, 1B (e.g., where islands of hydrophilic nanostructured features are surrounded by a hydrophobic field material).

In some embodiments, both the hydrophobic and hydrophilic materials are disposed over a seed layer. The seed layer may be of same or different composition as either of the hydrophobic or hydrophilic materials making up heterogeneous surface 101. As further illustrated in FIG. 1B, seed layer 107 forms an interface between substrate 105 as well as with a bottom surface of hydrophobic material within site 120. Film thickness of seed layer 107 may vary as needed to seed at least one of the hydrophobic and hydrophilic regions of a heterogeneous surface. In one exemplary ZnO embodiment, seed layer 107 is a ZnO film 10-1000 nm in thickness. Alternative seed layer compositions, such as, but not limited to Ag and Au, are also possible and may have a similar range of thickness.

In some embodiments, a heterogeneous surface includes a micrometer-dimensioned feature having a hydrophobic surface surrounded by a hydrophilic surface area comprising nanostructures. In further reference to FIG. 1B, site 120 is associated with a minimum lateral feature diameter D, which is advantageously at least 1 μm. In some specific embodiments where site 120 comprises PFPE and field material 120 comprises ZnO, diameter D is between 25 and 1000 μm (e.g., 75 μm, 100 μm, 200 μm, 300 μm). Although illustrated in FIG. 1A as an essentially circular dot shape, the shape may vary as a function of the printing process and/or substrate surface. For example, a dot that is circular when printed on a glass substrate may be somewhat distorted when the same printing process is employed to print a dot on a stainless steel substrate. Such distortion may be a result of milling marks on the stainless steel surface. Feature shapes other than dots are possible, such as an elongated trace, etc.

In some exemplary embodiments, a heterogeneous surface comprises a plurality of features (e.g., hydrophobic dots) spatially arrayed over the substrate surface. The spatial area may form any macroscopic pattern suited for the application. For example, the spatial array may provide a means for controlling boiling and/or condensing locations over a given substrate area, such as within a heat exchanger. One simple spatial array is a regular 2-D grid. Feature dimension (e.g., dot diameter) and pitch may be selected for the grid. Alternative regular dot array layouts are also possible. For example, a hexagonal (e.g., HCP) layout may be employed to achieve a desired fill factor in conjunction with a desired feature pitch and dot diameter. In other embodiments, the array pattern is irregular. Irregularity may be either in the form of varying feature dimension and/or feature pitch within the array, or by patterning a 2D array into macro shapes.

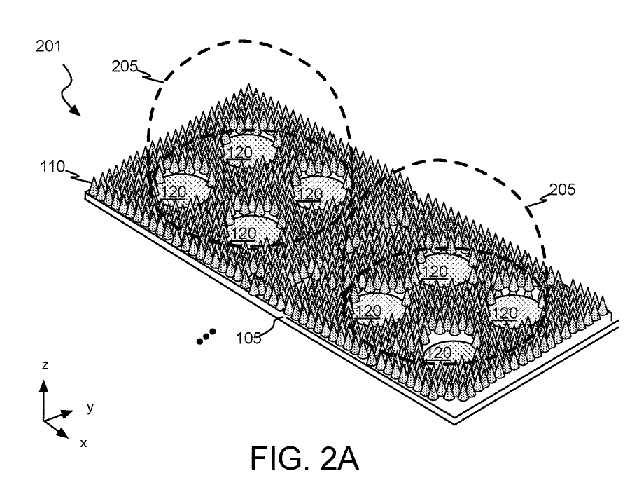

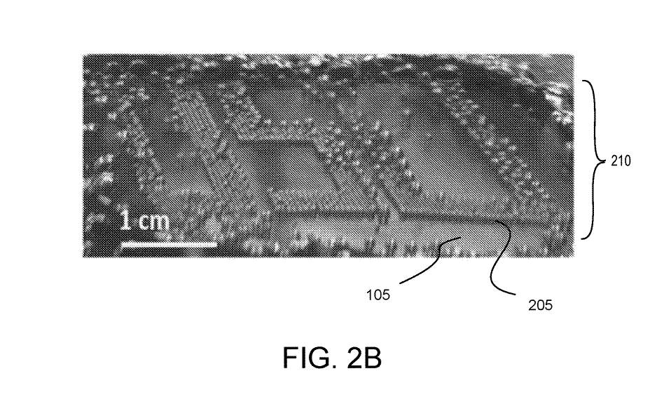

FIG. 2A illustrates an isometric view of an arrayed heterogeneous boiling surface 201, in accordance with some embodiments. Surface 201 includes a plurality of sites 120 spatially arrayed over substrate 105 and surrounded by field material 110 to form a network of interlaced wettability. Such a network may channel liquid to remove vapor nucleated on each localized growth site. Relative spatial positioning of sites 120 may also play a role in stabilizing bubble nucleation and/or controlling the merging of many bubbles. In the illustrated embodiment, the spatial array includes two sets of separate four-dot array patterns. Nearest neighboring sites 120 within each four-site set is spaced apart by a smaller distance than nearest neighboring sites 120 of the two adjacent four-site sets. Such an arrangement has been found by the inventors to be able to promote generation of a large single bubble 205 on each set of sites 120. In some further embodiments, nucleation on adjacent surface areas may be retarded by reducing the porosity of the nanostructured field material 110, for example by increasing the deposition time of the field material (e.g., ZnO). For such a pattern, it was found that, each bubble 205 had a base that was roughly the size of the respective four dot array, with an overall larger bubble size than the array pattern.

Bubble nucleation, growth, and departure were witnessed even at 80° C. water temperature, illustrating how the heterogeneous surface can lower the superheat for the bubble nucleation, enhance nucleate boiling heat transfer, and effectively tailor the location of the bubble nucleation. As such, heterogeneous surfaces in accordance with embodiments may be patterned into any form to spatially control bubble nucleation location. With the ability to spatially control bubble nucleation in this manner, nucleation sites may be confined to predetermined regions of any apparatus into which the heterogeneous surface is integrated. Spatial nucleation control may be employed, for example, to restrict boiling to a predefined locale. In some embodiments, a predetermined two-dimensional (2D) pattern comprising a plurality of sites spatially arrayed over a surface area of a substrate may be surrounded with a field material providing wettability contrast with the site material. Upon heating a liquid (e.g., DI waters) in contact with the 2D pattern to a sufficient temperature (e.g., 80-90° C.), a 2D pattern of vapor bubbles may be nucleated. As this 2D pattern is dependent on the 2D pattern of spatially arrayed sites, the vapor bubble array may be employed to convey information specified by the 2D pattern of spatially arrayed sites.

An apparatus to convey information through patterned bubble nucleation may include any predetermined two-dimensional (2D) pattern comprising a plurality of sites spatially arrayed over a surface area of a substrate. Each site comprising a first material may be further surrounded by a field material providing a wettability contrast with the first material. A liquid is in contact with the substrate surface, which a heater heats to a temperature sufficient to nucleate a 2D pattern of vapor bubbles that is dependent on the 2D pattern of sites and indicative of the information. FIG. 2B is an optical image of a spatially patterned bubble nucleation array 210 generated by an arrayed heterogeneous boiling surface, in accordance with some exemplary embodiments. As shown in FIG. 2B, within the test apparatus, bubbles 205 form in DI water contacting a heterogeneous surface region of substrate 105. Bubbles 205 nucleate regularly in a well-controlled manner at 80° C., forming a distinct binary image including alpha numeric characters “OSU” within a 4 cm×3 cm area. Each bubble within the binary image corresponds to one or more sites (e.g., four nearest neighboring sites) printed upon the substrate.

Within some exemplary dot arrays, dot sizes vary from 75 μm to 300 μm in diameter. Feature (dot) pitch within a heterogeneous surface array may also vary, for example between 1.5×5× the feature diameter. Pitch value has been found to have an impact on bubble nucleation and dynamics as the inventors have varied dot diameters (e.g., from 75 μm to 300 μm) while holding pitch constant (e.g., 500 μm) and also varied pitch values (e.g., from 250 μm to 1000 μm) for a constant dot size (e.g., 75 μm diameter).

### Methods of Fabricating Heterogeneous Surfaces

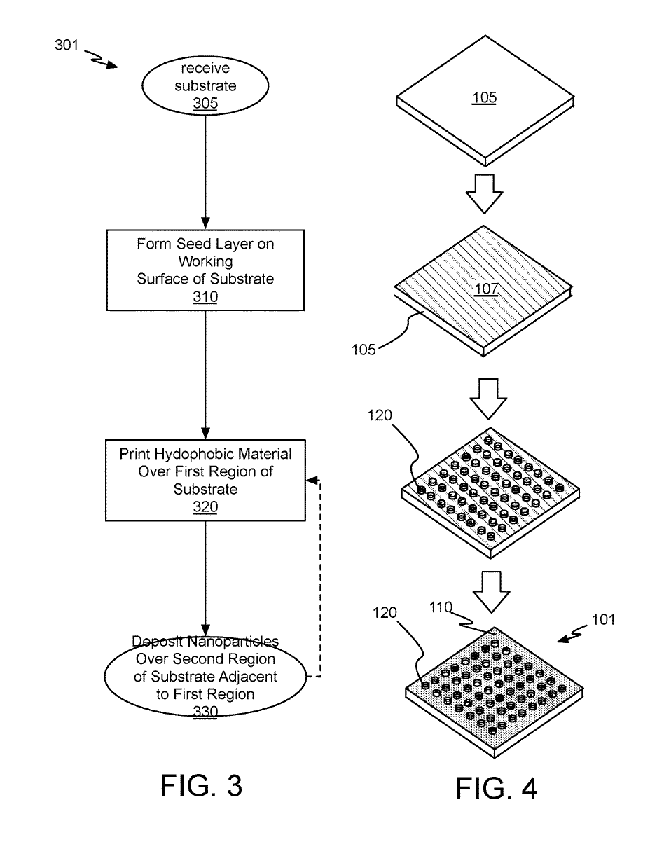

Heterogeneous surfaces having one or more of the structural features described for exemplary embodiments above may be fabricated through a variety of techniques. FIG. 3 illustrates some exemplary methods 301 for printing an array of hydrophobic dots and selectively depositing a hydrophilic field region there between. An evolution of a substrate as the heterogeneous surface is fabricated is further illustrated in FIG. 4.

Referring first to FIG. 3, methods 301 begin with receiving a suitable substrate at operation 305. The substrate may be, for example, be any of those described elsewhere herein, such as but not limited to stainless steel (e.g., SS 304). In some embodiments, a hydrophilic treatment of the substrate is also performed at operation 305. For example, the substrate surface may be exposed to a 1M NaOH solution for 30 min, followed by a cleaning process (e.g., acetone, methanol, and deionized (D.I.) water). The cleaned substrate is then dried (e.g., with nitrogen gas). FIG. 4 illustrates the exemplary substrate 105 as it may be received at operation 305.

Continuing with methods 301 (FIG. 3), at operation 310 a seed layer is formed over a working surface of the substrate. FIG. 4 illustrates the exemplary substrate 105 covered with seed layer 107. Depending on the substrate, the seed layer may be more or less important to subsequent operations in methods 301. For an exemplary stainless-steel (SS) substrate, the seed layer was found to be advantageous for subsequently facilitating a uniform ZnO nanostructure formation. The seed layer may be selectively deposited or blanket-deposited over all exposed substrate surfaces. In one exemplary embodiment, a blanket ZnO seed layer was first formed on a SS 304 substrate (2×2 cm). The inventors employed a microreactor-assisted nanomaterial deposition (MAND) process to form the seed layer. For characteristics of the MAND process and the detail on growing ZnO nanostructures, the interested reader is referred to commonly owned and/or assigned U.S. Pat. Nos. 8,553,333 and 7,846,489, both of which are incorporated herein by reference in their entirety for all purposes. Micromixer and/or microchannel application may also be suitable for depositing other nanostructured materials, for example as further described in commonly owned and/or assigned U.S. Pat. Nos. 8,236,599 and 8,801,979.

At operation 310 (FIG. 3), hydrophobic material is deposited over the seed layer. In some embodiments, operation 310 entails a printing process by which the hydrophobic material features may be deposited selectively to a first region of the substrate, for example forming a 2D dot array. Alternatively, the hydrophobic material may be blanket deposited and subsequently patterned (e.g., by known subtractive processing techniques). For some exemplary direct printing embodiments, fluorine-silane material is printed into dot arrays. One suitable fluorine-silane material (e.g., Fluorolink S10®) is commercially available through Solvay Solexis. According to the product data sheet, the material is composed of perfluoropolyether with ethoxysilane terminal groups, which reduces surface energy of applied substrates thereby improving repellency to water. The S10 material has a high kinematic viscosity of 18,000 cst at 20° C., which may be too high to be suitable for the use of ink in some printing apparatuses. A fluid of SU-8 developer commercially available through Microchem, was found to be a good diluent for the printable PFP ink. In one exemplary embodiment, 1.2 mL of PFPE was diluted with 2 mL of SU-8 developer. This volume ratio was determined to sustain the printer cartridge advantageously. In some printing embodiments, a piezoelectric inkjet printer is employed at operation 310. For example, a Dimatix DMP-2831 (commercially available through Fujifilm-Dimatix) may be used to deposit the polymer dot arrays. This printer head is composed of an array of 16 nozzles with 21.5 μm opening size. Stable droplets were ejected over the stainless steel (SS 304) substrate by setting 11.5 μs and 24 V pulse at a frequency of 20 kHz (FIG. 51). Printing pattern drawing was achieved by software installed in the printer.

In some embodiments, operation 310 further comprises a hydrophobic polymer ink curing process. As one example, the printed substrate may be exposed to an elevated temperature (e.g., 120° C. for 15 min., and 200° C. for another 15 min. on a hot plate). Operation 310 may be performed once or repeated one or more times to achieve a desired hydrophobic material film thickness. Repetition of operation 310 may be employed, for example, to achieve a desired recess height H2 (FIG. 1B). Repetition of operation 310 may also be employed for alternative embodiments where the printed features are proud of a field area that is to be subsequently formed to a predetermined thickness.

Methods 301 continue with operation 330 where the hydrophilic nanoparticles are deposited in a second region of the substrate adjacent to the first (printed) hydrophobic regions. In some exemplary embodiments, deposition of the hydrophilic material is selective to region(s) of the substrate not occupied by the hydrophobic polymer features. In other words, the hydrophobic polymer features block deposition of the hydrophilic material in the first region and are not covered over by the hydrophilic nanoparticles as they deposit over the second region of the substrate. In some exemplary embodiments show in FIG. 4, a MAND process was performed at operation 330 to form ZnO nanostructures as field material 120. Duration of the ZnO material growth may controlled to achieve a desired porosity as well as achieve a desired field material thickness relative to that of the hydrophobic features. In some exemplary “crater-forest” embodiments, ZnO nanostructures are deposited around printed PFPE surfaces for approximately 3 min.

Methods 301 are then either complete, or another iteration of operation 320 may be performed. Repetition of operation 320 following operation 330 may, for example, ensure there is no hydrophilic material artifacts originating from operation 330 within the confines of hydrophobic features 120. As described further below, heterogeneous surface 101 generated as an output of methods 301 may be further integrated into any suitable system, such as but not limited to a heat exchanger (HTX) in which heterogeneous surface 101 is to function as a boiling surface.

### Bubble Nucleation & Dynamics of Heterogeneous Surfaces

Boiling tests were performed to evaluate the bubble nucleation and dynamics on heterogeneous surfaces in accordance with some embodiments described herein. The surface was secured onto a glass container by pasting a high temperature silicone rubber sealant around the surfaces. DI water was used as a boiling fluid and was degassed by boiling the water for several hours. The degassed water was poured inside the glass container and the container was placed on a hot plate. A k-type thermocouple was immersed into the water to read the temperature of the water. The entire boiling processes from bubble nucleation to the bubble dynamic were captured by a HD video camera. The approach taken to analyze bubble dynamics involved quantification of the frequency of bubble release from viewing the boiling videos for each of the test surface configurations. A frame-by-frame analysis was conducted to record the time from observable nucleation to lift-off on areas of the surface that represented the general dynamics well. Some of the tested surfaces showed obvious irregular nucleation and hydrodynamics, so the best representative area was analyzed. Frame-by-frame analysis was done in Windows Live Movie Maker so that time stamps of formation and departure could be obtained by viewing individual bubbles. The time of departure was subtracted from the time of observable formation to obtain the frequency of release in bubbles/s (or Hz). The analysis was done on different coordinates of the boiling surface in order to determine average and standard deviation for each surface. Qualitative accounts of relative merging could also be made from the visualization test.

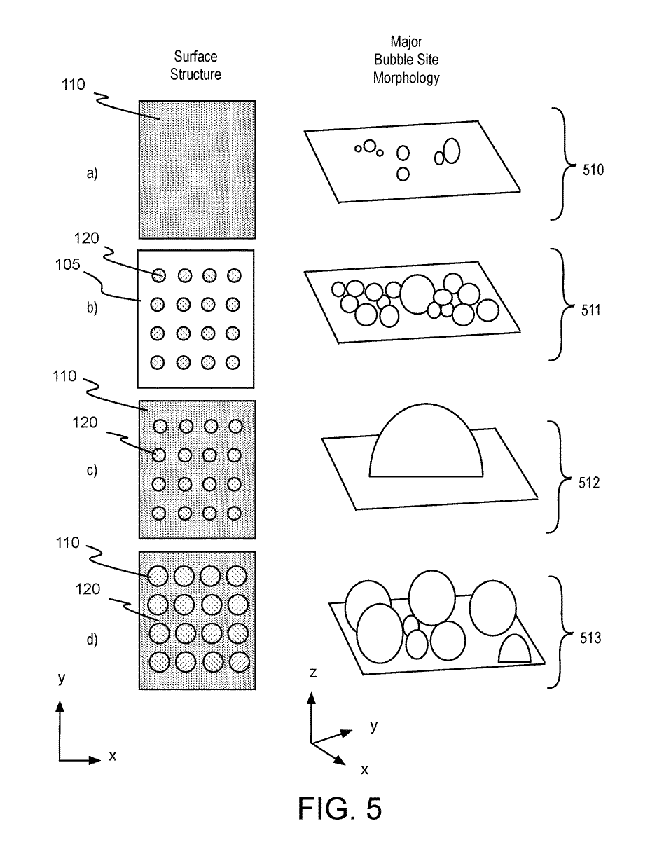

FIG. 5 illustrates heterogeneous boiling surfaces and corresponding major bubble site morphologies. Generally, as the printed dot size becomes larger, the size of nucleated bubble increases. While no bubbles were found to be generated on a bare stainless steel substrate at a reference heat flux corresponding to a water temperature of 80° C., both nanostructured surfaces and heterogeneous surfaces showed significant bubble nucleation and discernible differences in bubble dynamics were observed.

To highlight the important role of a proper hydrophilic and hydrophobic combination for the controlled bubble dynamics, homogeneously functional surfaces were tested. In FIG. 5, treatment a) has a homogenous surface comprising only field material 110. (e.g., hydrophilic ZnO nanowires). For such a surface, the associated bubble nucleation dynamics and morphology comprises relatively small separate, irregular sites 510. The formation of the irregular bubbles is likely due to micropores and nanopores that trap the air inside its surface. Treatment b) includes an array of hydrophobic features 120 (e.g., polymer dots with 150 μm diameter D at a pitch of 500 μm) disposed on substrate 105 with without field material 110 (e.g., without a ZnO matrix). For such a surface, the associated bubble nucleation dynamics and morphology comprises numerous nucleation sites 511 that remain separate or fail to coalesce. This “crater-alone” configuration had less merging, smaller bubble diameters, and considerably slower rate of release at the saturation temperature, indicating the importance of capillary wicking provided from the hydrophilic (e.g., ZnO) nanostructures. Insufficient wickability of the surface hinders bubble coalescence and leads to irreversible dry patches that lower the CHF. Therefore, good wicking structures can make the flushing process more reversible even when a massive bubble site is formed so that a more dense bubble can be released faster.

Treatment c) includes a bi-functional array of hydrophobic features 120 (e.g., polymer dots with 150 μm diameter D at a pitch of 500 μm) within a matrix of hydrophilic nanostructured field material 110 (e.g., ZnO matrix). For such a heterogeneous surface, the associated bubble nucleation dynamics and morphology comprises a single flattened, relatively large bubble 312 having a diameter spanning many sites in the array. Treatment d) includes a bi-functional array of hydrophobic features 120 (e.g., polymer dots with 300 μm diameter D at a pitch of 500 μm) within a matrix of hydrophilic nanostructured field material 110 (e.g., ZnO matrix). For such a heterogeneous surface, the associated bubble nucleation dynamics and morphology comprises relatively less bubble merging 513 than for treatment c) as the hydrophobic dot diameter D is further increased.

For a surface with 250 μm diameter dots at 1000 μm pitch, irregular bubbles formed in random locations on each surface, whereas the 500 and 750 μm pitch surfaces were covered with dense bubble arrays formed in a uniform and regular distribution. The number of bubbles in a row was counted to be 35 and 26 for the 500 and 750 μm pitch surfaces, respectively. These counted values are nearly equivalent to the number of printed polymer dots, indicating that bubbles were nucleated in polymer dots and evenly activated below the saturation temperature. These results also indicate that nucleated bubble size can be tailored by varying the pitch value with a given dot size. Assuming that the bubble nucleation originates from the interface between the polymer dot and the ZnO nanostructures, the pitch should affect the bubble growth and consequently the size of the formed bubble.

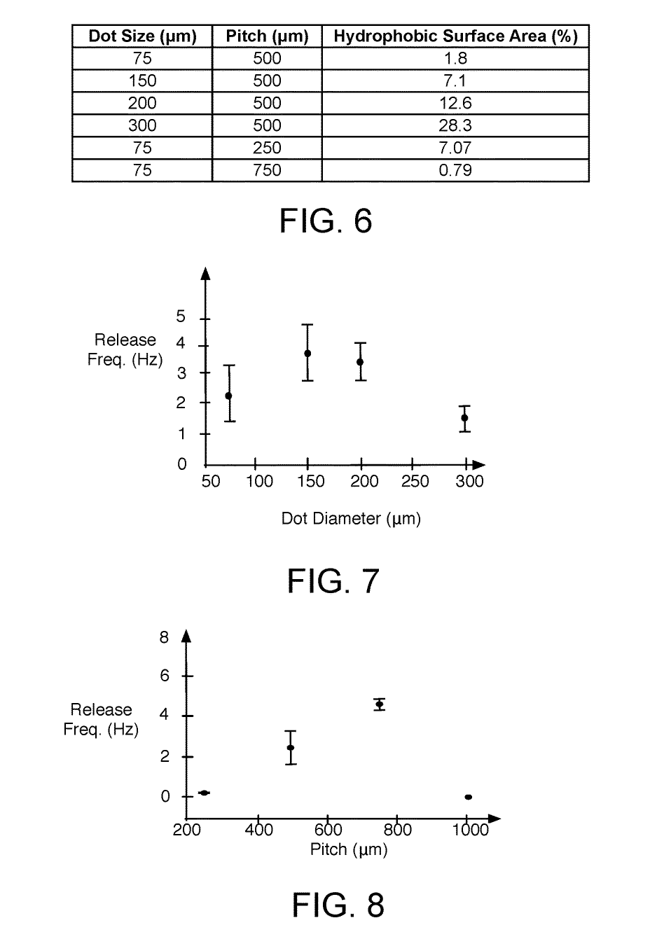

Based on the results of bubble dynamics at 80° C., one may conclude that the ratio of surface functionality should be optimized in order to induce uniformly distributed and isolated bubble nucleation. If one functionality dominates the other, the formation of the regular bubble nucleation would cease to occur. FIG. 6 is a table of diameters for printed dots employed as hydrophobic sites in a heterogeneous boiling surface, in accordance with some embodiments. As shown, for a sampling of embodiments spanning various combinations of feature diameter D and feature pitch, the hydrophobic area ratio to the hydrophilic area varies from 0.8 to 1.8%.

Heat flux was continually supplied to boiling surfaces to reach the saturation temperature (100° C.). It turned out that the surfaces of 250 and 1000 μm pitch create a few bubbles with irregular bubble release frequency even at the saturation temperature. FIG. 2 f and g display the bubble dynamics of the 500 and 750 μm surfaces, which showed regular and isolated bubble nucleation at 80° C. On the contrary to the similar bubble nucleation behaviors observed at 80° C., the bubble dynamics of the 500 and 750 μm pitch surfaces at the saturation temperature are obviously different. The 500 μm pitch surface exhibited uneven bubble dynamics over the surface. The size evolution progresses from observable nucleation to massive bubbles, followed by lift-off. The bubble diameter also varied across the surface. Furthermore, bubble merging took place as the bubbles grew larger, and the merging pattern varied across the surface. The 750 μm pitch surface appeared to have uniform bubble nucleation and bubble diameter as well at the saturation temperature. A noteworthy difference was the larger bubble size and much faster rate of release, as expected at higher temperature. Lift-off could not be examined accurately because the vapor bubbles detached incredibly fast, most likely due to their low density and high capillary action from the supporting forest structures. The different bubble dynamics between 500 and 750 μm pitch surfaces at the saturation temperature indicates the pitch effect on bubble coalescence. At the smaller pitch of 500 μm, the bubbles nucleated at low superheat have higher chance to combine with the neighboring bubbles as the nucleated bubbles grow at increased super heat. At the 750 μm pitch, on the other hand, the pitch is distant enough that bubbles do not contact neighboring bubbles, resulting in the separate bubble forming even at the high superheat. Notably, the surface with 75 μm diameter hydrophobic sites at a 750 μm pitch provided the best control of bubble size with relatively less merging than other configurations.

Hydrophobic feature diameter D was also found to be important. Observation of bubble dynamics below the saturation temperature indicate larger hydrophobic craters lead to larger bubble diameters. For the dot diameters of 75 μm and 150 μm, the nucleation of smaller bubbles was observed at 80° C. However, larger bubbles were nucleated at 90° C. for 200 μm and 300 μm dot diameters. Bubbles on the larger dot surfaces barely nucleated at 80° C. This is due to the fact that a higher superheat (i.e., difference in saturation temperature of fluid and heated surface temperature) is required to activate nucleation of the larger hydrophobic area, compared to smaller ones. An advancing liquid front would not wet the hydrophobic crater, and the liquid would travel over the crater, thereby trapping the gas within the crater (vapor entrapment) to create a liquid-gas interface. Therefore, when larger crater sizes are used, the liquid-gas interfacial area increases, which requires more superheat for activation, thereby resulting in observable bubble nucleation at 90° C. instead of 80° C. for the larger crater configurations. Once nucleation is initiated and the contact line is activated, the larger interfacial area causes larger bubbles to be formed from the increased interfacial area.

At 100° C. the surface configuration with 150 μm diameter dots at 500 μm pitch promoted the growth of a single major bubble, with the highest observable diameter seen by the inventors, and a relatively high release frequency (FIG. 7). Nucleation and growth appeared to occur instantaneously (<0.1 s) once the bubble departed, and was unobservable to the naked eye. A faster frame capture may allow one to see the multiple flattened bubbles quickly coalescing into a single major one. From the frame-by-frame analysis, a few flattened bubbles and extreme merging phenomena were observed. The flattened bubble shape is thought to be caused by the merging of many active sites, and is much different than the bubble morphologies seen from other surface configurations.

It was found that the massive merging and flattened bubble shape only took place on the surface configuration with 150 μm diameter dots at 500 μm pitch. This massive merging spectacle did not occur as the dot size was increased further to 200 μm. The 200 μm dot size configuration had 5 major bubble sites and the sites stayed separate without merging into one giant bubble. A further increase in the hydrophobic dot size to 300 μm increased the number of major bubble sites from the 200 μm dot case. The number of major sites increased to more than 6, from 5 major sites seen with 200 μm.

Although not limited by theory, the inventors propose some explanations regarding the gigantic single bubble formation on the surface configuration with 150 μm diameter dots at 500 μm pitch. Perhaps, upon approaching the saturation temperature, all the cavities are activated generating bubbles with high density, and subsequently bubbles begin to merge. The merging motion is augmented by migration of the bubbles that is driven by the surface energy difference acting on bubbles. The bubbles sitting on the hydrophilic area tend to move toward the hydrophobic area, which has a lower surface energy. The migrated bubbles would merge with the bubbles nucleated on the hydrophobic area, resulting in the larger bubble formation. In addition to surface energy driven merging, lateral merging would be promoted from the wicking action that could transport the nucleated bubbles during the replenishment of liquid. The capillary wicking also plays an important role in releasing the gigantic bubble with high frequency by forming an interconnected network to replenish liquid. The network promptly channels liquid to remove the vapor on the localized growth site. The replenishment allows for even more liquid that arrives on the major site to undergo phase change to vapor. A combination of these effects could also explain why the merging and growth occurred so quickly. It is also conjectured that this interconnected network is formed from the optimal pitch and dot size configuration of the 150-500 μm surface.

For the crater configuration higher than 200 μm dot size, the widespread network channeling did not appear due to the decreased mixing action. The binding force threshold must be overcome to move each bubble sitting in a crater from increased motion through the hydrophilic wicking structure. As the crater size is increased, it is expected that larger bubbles with associated larger vapor pressure require a higher force to move them for mixing. Consequently the liquid flow is insufficient to flush the area and cause the bubbles to merge as efficiently in cases with 200 μm dot size and above. Accordingly the inventors observed a decline in merging as the crater size was increased. In addition, the decreased release frequency of larger crater sizes also evidences weakening wicking force as the crater size increases. More efficient wicking structures should be in place surrounding each crater to flush at a high force, thereby mixing the vapor sitting in each crater and inducing widespread liquid channeling.

Bubble release frequency was also assessed from viewing boiling videos. FIGS. 7 and 8 are graphs of the bubble departure frequency as a function of printed dot diameter and pitch, in accordance with some embodiments. FIG. 7 illustrates the frequency as a function of feature (e.g., dot) size variation at constant pitch of 500 μm. FIG. 8 shows the frequency as a function of pitch at a constant feature diameter of 75 μm. Bubble release frequency is known to be directly related to the efficiency of capillary pumping, or wickability of a surface. This is due to the enhanced lift-off effect of bubbles when liquid (e.g., water) is pumped to the active site, thereby re-wetting the active site promptly. To prevent vapor dry-out and increase the CHF, re-wetting properties (releasing bubbles faster) are desirable. Faster release rates also mean that relatively more phase change occurs, so the HTC should also increase due to increased energy transfer from the latent heat of vaporization. The denser bubble nucleation of the 150 μm dot array also displays a higher release than the less dense bubbles formed from the 200 and 300 μm dot size arrays. The largest recorded rate of release was 4.5 Hz, for the 75 μm dot diameter at 750 μm dot pitch. It was also noted above that this configuration had the best control of bubble diameter and uniformity across the surface at the reference heat fluxes.

The lowest rate of 0 Hz occurred on the 75 μm dot diameter D at 1000 μm dot pitch surface because nearly no nucleation was observed. This may be because incipience of vapor bubbles is delayed in almost perfectly wetting surfaces. It may be that for such a heterogeneous surface configuration, the liquid spreads too quickly and floods the hydrophobic crater sites. The flooding movement of liquid throughout the forest structure impeded and hindered nucleation potential. For a site to promote nucleation, it is currently believed that there needs to be sufficient enclosure. This implies that the a dot diameter of 75 μm may be too small for a crater to provide sufficient enclosure when combined with a dominant hydrophilic wicking forest. Thus, for an overly hydrophilic surface, better nucleation performance may be possible for larger hydrophobic features (e.g., larger dot diameter).

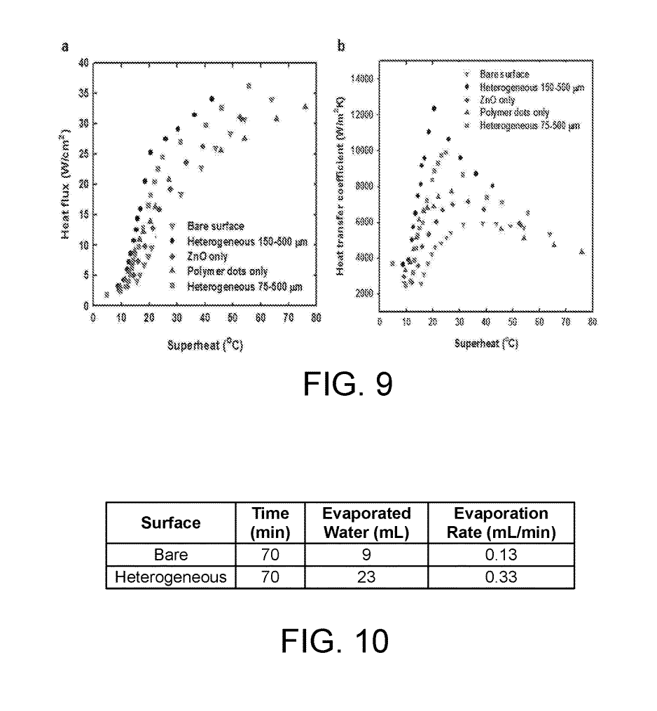

FIG. 9A illustrates a comparison of DI water boiling curves for a bare substrate (e.g., mirror finish SS 304), treatments a), b) and c) illustrated in FIG. 5, as well as a heterogeneous surface with a 75 μm dot diameter at 500 μm pitch. In the test set-up, the test surface (4 cm in diameter) was secured on large stainless steel disk and enclosed by a long glass tubing. 150 mL D.I. water was filled in the tubing. The test apparatus was placed on a hot plate. Time was measured immediately after the heating. After 70 min of boiling, the volume of the water in the tubing was measured. Based on the amount of the evaporated water and time, the evaporation rate was estimated. The boiling test of the heterogeneous bi-functional surface was iterated several times for about 40 minutes in each test. The surface was found to be functional after several repeated tests without any noticeable boiling degradation.

As shown in FIG. 9A, the boiling curves for the heterogeneous surfaces are shifted to have significantly higher heat flux for a given superheat, or lower superheat for a given heat flux, with this difference increasing at higher heat flux. FIG. 9B illustrates corresponding heat transfer coefficient of the tested boiling surfaces as a function of wall superheat. All heterogeneous surfaces show improved heat transfer at lower superheat compared to the bare surface. The results further indicate that the surface with 150 μm dot diameter at 500 μm pitch is more effective than the surface with 75 μm dot diameter at 500 μm pitch in terms of enhancing boiling heat transfer rate. Up to the tested heat flux around 35 W/cm2, the heterogeneous surfaces have shown significant reduction of wall superheat, which is also clearly demonstrated in their boiling heat transfer coefficient in FIG. 9b. Given the trends, at low-to-medium heat fluxes (10-25 W/cm2), up to 3× of heat flux was observed for a given wall superheat for the bi-functional surfaces. Although the percentage of increase of heat flux is reduced at higher fluxes, the amount of increased heat flux was still quite significant for the bi-functional surfaces. This leads to a reasonable expectation of markedly higher CHF as both nucleate boiling and capillary pumping were deliberately introduced. As also observed in the bubble dynamics study, the bi-functional surface with 150 μm dot diameter at 500 μm pitch outperformed the surface with 75 μm dot diameter at 500 μm pitch in the pool boiling experiment. For the same heat flux, its wall superheat was reduced as a result of increased nucleate boiling sites for 150 μm dots, which also manifested itself in terms of boiling HTC as shown in FIG. 9b. Compared to heterogeneous bi-functional surfaces, both surfaces with only ZnO or only printed polymer dots showed less boiling enhancement. Although the surface with only a printed polymer dot array showed nucleate boiling enhancement at lower-to-medium heat flux (up to 20 W/cm2), its performance dropped off quickly with further increase in heat flux, which again indicates the importance of wicking action in order to prevent local dry-out. The surface with only ZnO performed reasonably well throughout the applied heat fluxes, although no drastic enhancement of nucleate boiling occurred in comparison to the other enhanced surfaces.

Evaporation rate test results are illustrated in FIG. 10 for one exemplary heterogeneous surface with 150 μm dot diameter at 500 μm pitch. Estimated evaporation rate for the heterogeneous surface is nearly 3× that of the bare surface.

The heterogeneous surfaces described above and their associated methods of manufacture may be readily applied to a variety of applications, such as but not limited to concentrated photovoltaics, lasers, radars, and power electronics. One advantage of the heterogeneous surface architectures and the methods of manufacturing described herein is the ease of the scale-up. For example, a 6 inch wafer-sized stainless steel substrate may be readily processed to include a plurality of different heterogeneous surfaces For example, one substrate may host a first heterogeneous surface (e.g., with 150 μm dots at 500 μm pitch), and a second heterogeneous surface (e.g., with 75 μm dots at 500 μm pitch). Iterative printing of patterned arrays of different hydrophobic materials is possible and may be performed as needed for a given application.

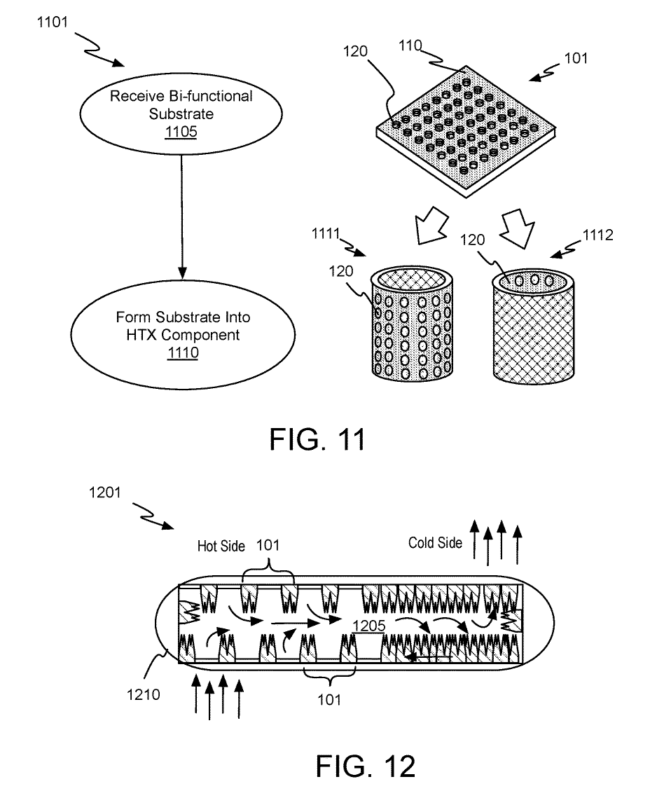

FIG. 11 is a flow diagram and schematic illustrating methods 1101 whereby a substrate with a heterogeneous boiling surface received at operation 1105 is integrated into a heat exchanger at operation 1110, in accordance with some embodiments. The substrate received at operation 1105 is advantageously of a thickness that ensures the substrate has sufficient flexibility form subsequent forming into a component surface of the heat exchanger at operation 1110. For some embodiments, a bi-functional surface (e.g., any of those described elsewhere herein) fabricated on a flexible substrate having sufficiently high thermal conductivity (e.g., a stainless steel or copper sheet good) is received at operation 1105.

At operation 1110, the flexible bi-functional sheet is shaped into and/or bonded to a 3D heat exchanger tube using any suitable process known in the art. In some embodiments, the flexible bi-functional sheet is rolled with the bi-functional surface on an exterior surface of a tube 1111 suitable for conveying a working liquid. In other embodiments, the flexible bi-functional sheet is rolled with the bi-functional surface on an interior surface of a tube 1112 suitable for conveying a working liquid. In some other embodiments, the flexible bi-functional sheet is wrapped and bonded to an underlayment, with the bi-functional surface on an external surface, opposite the underlayment. The underlayment may for example be a prefabricated tube or other 3D object.

Heat Pipe with Heterogeneous Surface

FIG. 12 illustrates a cross-sectional view of an exemplary heat pipe 1201 employing a heterogeneous boiling surface, which may be fabricated by practicing an embodiment of methods 1101. In some embodiments, a heat exchanger employing liquid-vapor phase transition includes a heterogeneous boiling surface, for example having one or more of the properties and/or attributes described elsewhere herein. Such a heat exchanger may have a biphilic working surface including a spatial array of features comprising a hydrophobic or hydrophilic material of a first nominal thickness within a field comprising hydrophilic or hydrophobic material of a second nominal thickness. Sites of hydrophobic material may have a top surface recesses from a top surface of the hydrophilic material, for example as described elsewhere herein.

As shown in FIG. 12, a working fluid 1205 is contained within sealed vessel 1210. At least a portion of an inner surface of vessel 1210 comprises the heterogeneous surface 101, for example substantially as described above. Working fluid 1205 is saturated at the operating temperature of the hot side and evaporates from heterogeneous surface 101, absorbing latent heat of evaporation. Vaporized working fluid migrates within chamber volume to a cold side of vessel 1210 where it condenses back to fluid, releasing latent heat of condensation. Working fluid 1205 is wicked by hydrophilic nanostructures exerting capillary action and is transported back to the vessel hot side. In some embodiments, only a portion of the inner surface of chamber wall 1210 has a heterogeneous surface (e.g., hot or boiling side). In alternative embodiments, substantially the entire inner surface of the chamber wall 1210 has a heterogeneous surface although boiling need not occur over the entire heterogeneous surface area. For such embodiments, recessed hydrophobic sites lacking sufficient superheat may provide local driving forces incrementally assisting macro fluid transport between condenser and evaporator ends. In still other embodiments, a first portion of the inner surface of chamber wall 1210 has a first heterogeneous surface (e.g., including recessed hydrophobic sites as described elsewhere herein) while a second portion of the inner surface of chamber wall 1210 has a second heterogeneous surface with different characteristics (e.g., including raised hydrophobic sites and/or hydrophobic sites of different material composition, and/or recessed hydrophilic sites and/or hydrophilic sites of different material composition).

While certain features set forth herein have been described with reference to embodiments, this description is not intended to be construed in a limiting sense. Hence, various modifications of the implementations described herein, as well as other implementations, which are apparent to persons skilled in the art to which the present disclosure pertains are deemed to be within the spirit and scope of the present disclosure.

It will be recognized that the embodiments are not limited to the exemplary embodiments so described, but can be practiced with modification and alteration without departing from the scope of the appended claims. For example, the above embodiments may include specific combination of features. However, the above embodiments are not limited in this regard and, in embodiments, the above embodiments may include undertaking only a subset of such features, undertaking a different order of such features, undertaking a different combination of such features, and/or undertaking additional features than those features explicitly listed.

What is claimed is:

1. An apparatus, comprising:
a substrate;
a hydrophobic thin-film material disposed on a first region of the substrate; and
a hydrophilic nanostructured thin-film material disposed on a second region of the substrate adjacent to the first region, wherein a top surface of the hydrophobic material is recessed below a top surface of the hydrophilic material.

2. The apparatus of claim 1, wherein:
an average thickness of the hydrophobic thin-film material is less than that of the hydrophilic material.

3. The apparatus of claim 1, wherein:
the hydrophobic material comprises a polymer dot having a lateral dimension of at least 1 μm; and
the hydrophilic material surrounds a circumference of the polymer dot.

4. The apparatus of claim 3, wherein:
the hydrophobic material has a film thickness of at least 10 nm;
the hydrophilic material comprises nanoparticles having a average diameter of less than 400 nm and has a film thickness of at least 100 nm; and
the top surface of the of the hydrophobic material is recessed from a top surface of the hydrophilic material by at least 10 nm.

5. The apparatus of claim 1, wherein:
the hydrophobic thin-film material comprises PFPE; and
the hydrophilic thin-film material comprises ZnO.

6. A heat exchanger vessel having a biphilic working surface including a spatial array of features comprising a hydrophobic or hydrophilic material of a first nominal thickness within a field comprising hydrophilic or hydrophobic material of a second nominal thickness.

7. The heat exchanger vessel of claim 6, wherein the first nominal thickness is less than the second nominal thickness.

8. The heat exchanger vessel of claim 7, wherein:
the first nominal thickness is 10-1000 nm; and
the second nominal thickness is 100-10,000 nm.

9. The heat exchanger vessel of claim 6, wherein:
each of the features comprises a hydrophobic material; and
the field comprises a hydrophilic nanostructured material.

10. The heat exchanger vessel of claim 6, wherein:
each of the features comprises a polymer dot having a lateral dimension of at least 1 μm; and
the hydrophilic nanostructured material comprises nanoparticles having an average diameter less than 400 nm.

11. The heat exchanger vessel of claim 6, wherein:
each of the features comprises a hydrophilic nanostructured material; and
the field comprises a hydrophilic material.

12. The vessel of claim 11, wherein:
each of the features has a lateral dimension of at least 1 μm; and
the hydrophilic nanostructured material comprises nanoparticles having an average diameter less than 400 nm.

13. The vessel of claim 6, wherein the spatial array spans an area of at least 1 mm².

14. The vessel of claim 6, wherein:
the spatial array comprises a plurality of feature sets, nearest neighbors within a set spaced apart by a smaller distance than nearest neighbors of two adjacent sets.

15. A heat exchanger, comprising:
a vessel having an heterogeneous interior surface comprising:
a spatial array of features disposed over a first region of the vessel, each feature further comprising a hydrophobic material, and having a lateral dimension of at least 1 μm; and
a hydrophilic nanostructured material disposed over the first region and surrounding the features within the array, wherein a top surface of the hydrophobic material is recessed below a top surface of the hydrophilic nanostructured material.

16. The heat exchanger of claim 15, wherein the hydrophilic nanostructured material is to conduct a working fluid toward one or more of the hydrophobic material features.

17. The heat exchanger of claim 16, further comprising the working fluid disposed within the vessel, the working fluid to evaporate from the hydrophobic material.

18. The heat exchanger of claim 17, wherein the working fluid is further to condense upon the hydrophilic nanostructured thin-film material.

19. The heat exchanger of claim 15, wherein:
the hydrophobic material has a film thickness of at least 10 nm;
the hydrophilic material comprises nanoparticles having a average diameter of less than 400 nm, and has a film thickness of at least 100 nm; and
the top surface of the of the hydrophobic material is recessed from a top surface of the hydrophilic material by at least 10 nm.

20. A method of fabricating a heterogeneous surface on a substrate, the method comprising:
receiving the substrate;
printing a hydrophobic or hydrophilic material feature over a first region of the substrate;
drying or curing the printed material; and
selectively depositing a hydrophilic or hydrophobic nanostructured thin-film material over a second region of the substrate adjacent to the hydrophobic thin-film material feature.

21. The method of claim 20, wherein:
printing the hydrophobic or hydrophilic material further comprises printing a spatial array of hydrophobic material features over the substrate.

22. The method of claim 21, wherein the presence of the hydrophobic material feature blocks deposition of the hydrophilic nanostructured thin-film material within the first region.

23. The method of claim 21, further comprising:
depositing a seed layer over the first and second regions of the substrate; and
wherein:
printing the feature over the first region further comprises printing a hydrophobic thin-film dot over the seed layer; and
selectively depositing the nanostructured thin-film material further comprises depositing a hydrophilic nanostructured thin-film material over the seed layer where not masked by the hydrophobic thin-film dot.

24. The method of claim 21, wherein the printing further comprises inkjet printing of a hydrophobic polymer dot array.

25. The method of claim 21, wherein the selective deposition further comprises a solution-based deposition. Microreactor-Assisted Nanoparticle Deposition.

26. A method of conveying information, the method comprising:
forming a predetermined two-dimensional (2D) pattern comprising a plurality of sites spatially arrayed over a surface area of a substrate, each site comprising a first material;
forming a field material over the substrate and surrounding the sites, wherein the field material provides a wettability contrast with the first material;
contacting the substrate surface area with a liquid; and
heating the liquid to a temperature sufficient to nucleate a 2D pattern of vapor bubbles that is dependent on the 2D pattern of sites and indicative of the information.

27. The method of claim 26, wherein the 2D pattern of vapor bubbles forms a binary image with each of the vapor bubbles corresponding to one or more of the sites.

28. The method of claim 26, wherein the binary image comprises one or more alpha numeric character.

29. The method of claim 26, wherein forming the 2D pattern of sites further comprises:
printing a hydrophobic or hydrophilic material feature over a first region of the substrate;
drying or curing the printed material; and
selectively depositing a hydrophilic or hydrophobic nanostructured thin-film material over a second region of the substrate adjacent to the hydrophobic thin-film material feature.

30. An apparatus for conveying information, the method comprising:
a predetermined two-dimensional (2D) pattern comprising a plurality of sites spatially arrayed over a surface area of a substrate, each site comprising a first material;
a field material over the substrate and surrounding the sites, wherein the field material provides a wettability contrast with the first material;
a liquid in contact with the substrate surface area; and
a heater to heat the liquid to a temperature sufficient to nucleate a 2D pattern of vapor bubbles that is dependent on the 2D pattern of sites and indicative of the information.

31. The apparatus of claim 20, wherein the 2D pattern of vapor bubbles forms a binary image with each of the vapor bubbles corresponding to one or more of the sites.

32. The method of claim 26, wherein the binary image comprises one or more alpha numeric character.
